(19) United States
(12) Patent Application Publication
(10) Pub. No.: US 2018/0308603 A1
(43) Pub. Date: Oct. 25, 2018

(54) Conductive Paste and Conductive Film

(71) Applicant: DOWA Electronics Materials Co., Ltd., Chiyoda-ku, Tokyo (JP)

(72) Inventors: Taku Okano, Chiyoda-ku, Tokyo (JP); Noriaki Nogami, Chiyoda-ku, Tokyo (JP); Yoshio Moteki, Chiyoda-ku, Tokyo (JP)

(21) Appl. No.: 15/763,334

(22) PCT Filed: Sep. 23, 2016
(86) PCT No.: PCT/JP2016/078101

§ 371 Date: Mar. 26, 2018

(30) Foreign Application Priority Data
Sep. 30, 2015 (JP) 2015-194516
Nov. 27, 2015 (JP) 2015-232404

(51) Int. Cl. H01B 1/22; H01B 1/24; C08L 63/00; C08K 3/04; C08K 3/08

(52) U.S. Cl. CPC H01B 1/22; H01B 1/24; C08L 63/00; C08K 2201/001; C08K 3/08; C08K 2003/0806; C08K 3/042

(57) ABSTRACT

To provide a conductive paste including: a filler containing a silver powder and a graphite powder; a polymer; and a solvent, where a 1%-weight-reduction starting temperature of the graphite powder, which is determined through a thermogravimetry-differential thermal analysis method, is 300° C. or more but 640° C. or less.

### TECHNICAL FIELD

The present invention relates to a conductive paste and a conductive film.

### BACKGROUND ART

Conventionally, a conductive paste obtained by dispersing a metal filler such as a silver powder in a resin has been used in order to form, for example, electrodes or circuits, electromagnetic wave shield films, and electromagnetic wave shield materials of electronic components.

In recent years, as electronic components having a high density are rapidly developed, improvement in workability in mass production and cost saving have become important issues. Therefore, a conductive film prepared from the conductive paste is strongly required to be improved in an electrically conductive property. At the same time, in order to release heat generated when electricity is allowed to pass through the conductive film, the conductive film is required to be improved in a thermal conductive property.

When a metal filler such as a silver powder is loaded at a high concentration in order to obtain such a conductive paste, a decrease in workability of the coating due to high viscosity, ununiformity of the conductive paste due to precipitation of the metal filler, and a thickened film of the conductive film will occur. The solvent, which has been added in order to decrease viscosity, is scattered during heating to thereby cause voids, resulting in defects such as a decrease in a thermal conductive property at the connection part and an increase in electric resistance.

In order to solve the aforementioned problems, there has been provided a conductive paste containing a conductive fine powder excluding carbon (A), a carbon powder (B), a binding agent (C), and a solvent (D) as main components, where a ratio (A)/(B) between the conductive fine powder (A) and the carbon powder (B) is 99.9/0.1 to 93/7 (see, for example, PTL 1).

### CITATION LIST

### Patent Literature

PTL 1: Japanese Patent Application Laid-Open (JP-A) No. 01-159905

### SUMMARY OF INVENTION

### Technical Problem

Even in the aforementioned proposal, however, a conductive paste capable of forming a conductive film excellent in an electrically conductive property and a thermally conductive property is not obtained. Therefore, rapid provision of the aforementioned conductive paste is needed.

The present invention solves the existing problems in the art and aims to achieve the following object. Specifically, an object of the present invention is to provide: a conductive paste capable of forming a conductive film excellent in an electrically conductive property and a thermally conductive property; and a conductive film.

### Solution to Problem

Means for solving the problems are as follows. That is,

<1> A conductive paste including:
a filler containing a silver powder and a graphite powder;
a polymer; and
a solvent,
wherein a 1%-weight-reduction starting temperature of the graphite powder, which is determined through a thermogravimetry·differential thermal analysis method, is 300° C. or more but 640° C. or less.
<2> The conductive paste according to <1>,
wherein the 1%-weight-reduction starting temperature of the graphite powder, which is determined through the thermogravimetry differential thermal analysis method, is 500° C. or more but 600° C. or less.
<3> The conductive paste according to <1> or <2>,
wherein the graphite powder is at least one selected from a graphene, a spheroidal graphite, and a flake graphite.
<4> The conductive paste according to any one of <1> to <3>,
wherein an amount of the graphite powder is 0.1% by mass or more but 10% by mass or less relative to a total amount of the filler.
<5> The conductive paste according to any one of <1> to <4>,
wherein the silver powder is a mixture of a flaky silver powder and a spherical silver powder.
<6> The conductive paste according to any one of <1> to <5>,
wherein the polymer is an epoxy resin.
<7> A conductive film,
which is formed of the conductive paste according to any one of <1> to <6>.
<8> The conductive film according to <7>,
wherein the conductive film has a volume resistivity of 100 μΩ·cm or less and a thermal conductivity of 10 W/m·K or more.

### Advantageous Effects of Invention

According to the present invention, it is possible to solve the existing problems in the art and to provide: a conductive paste capable of forming a conductive film excellent in an electrically conductive property and a thermally conductive property; and a conductive film.

### BRIEF DESCRIPTION OF DRAWINGS

FIG. 1 is a graph presenting evaluation results of TG and DTA of graphite powder No. 1 used in Example 1, which are measured through the thermogravimetry·differential thermal analysis method.

FIG. 2 is a graph presenting evaluation results of TG and DTA of graphite powder No. 2 used in Example 2, which are measured through the thermogravimetry·differential thermal analysis method.

FIG. 3 is a graph presenting evaluation results of TG and DTA of graphite powder No. 3 used in Example 3, which are measured through the thermogravimetry·differential thermal analysis method.

FIG. 4 is a graph presenting evaluation results of TG and DTA of graphite powder No. 4 used in Example 4, which are measured through the thermogravimetry·differential thermal analysis method.

FIG. 5 is a graph presenting evaluation results of TG and DTA of graphite powder No. 5 used in Comparative Example 2, which are measured through the thermogravimetry·differential thermal analysis method.

FIG. 6 is a scanning electron microscopic image of the silver powder No. 1 (flaky silver powder) used in Example 1.

FIG. 7 is a scanning electron microscopic image of the silver powder No. 2 (spherical silver powder) used in Example 2.

### DESCRIPTION OF EMBODIMENTS

### (Conductive Paste)

A conductive paste of the present invention includes a filler, a polymer, and a solvent, and further includes other components if necessary.

### <Filler>

The filler includes a silver powder and a graphite powder.

An amount of the filler is preferably 80% by mass or more but 95% by mass or less relative to the total amount of the conductive paste. When the amount is less than 80% by mass, a conductive film formed of the conductive paste may be deteriorated in a thermally conductive property and an electrically conductive property. When the amount is more than 95% by mass, coating workability of the conductive paste will be deteriorated. As a result, an appropriate conductive film cannot be obtained in some cases.

### —Graphite Powder—

A 1%-weight-reduction starting temperature of the graphite powder, which is determined through the thermogravimetry·differential thermal analysis method (TG-DTA method), is 300° C. or more but 640° C. or less, preferably 500° C. or more but 600° C. or less. The 1%-weight-reduction starting temperature of the graphite powder is more than 640° C., sinterability with silver will be deteriorated, which may adversely affect transfer of heat and electricity.

When the 1%-weight-reduction starting temperature of the graphite powder is 300° C. or more but 640° C. or less, a conductive paste capable of forming the conductive 0.5 film excellent in an electrically conductive property and a thermally conductive property can be obtained.

Here, the 1%-weight-reduction starting temperature can be determined through the thermogravimetry·differential thermal analysis method (TG-DTA method) in a nitrogen atmosphere at a heating speed of 10° C./min. Specifically, a thermal differential balance TG8120 (manufactured by Rigaku Corporation) can be used to determine the 1%-weight-reduction starting temperature as a temperature at which the weight is reduced by 1%.

The graphite powder is not particularly limited and may be appropriately selected depending on the intended purpose, so long as the 1%-weight-reduction starting temperature of the graphite powder, which is determined through the thermogravimetry·differential thermal analysis method (TG-DTA method), is 300° C. or more but 640° C. or less. The graphite powder is preferably at least one selected from a graphene, a spheroidal graphite, and a flake graphite. A graphene and a spheroidal graphite are more preferable in terms of thermal conductivity.

The spheroidal graphite and the flake graphite are substances in which carbons are bound in a hexagonal form by the covalent bond and the layers are bound by the van der Waals force. The spheroidal graphite and the flake graphite preferably have a thermal conductivity of 300 W/m·K or more but 1,500 W/m·K or less.

The graphene is a planar substance having a thickness equivalent to one carbon atom and is formed of crystal lattices having a honeycomb structure formed by the sp² bond of carbon atoms. The graphene is a basic building block of all the materials having any other dimensions. When the graphene is rounded, fullerene can be obtained. When the graphene is rolled, carbon nanotube can be obtained. When sheets of the graphene are stacked, graphite can be obtained. A thermal conductivity of the graphene is preferably 3,000 W/m·K or more.

As the graphite powder, an appropriately produced product may be used or a commercially available product may be used.

Examples of the commercially available product of the graphite powder include a graphene (GNH-X2, manufactured by Graphene Platform Corp.), a spheroidal graphite (WF-15C, manufactured by Chuetsu Graphite Works Co., Ltd.), a flake graphite (BF-15AK, manufactured by Chuetsu Graphite Works Co., Ltd.).

An amount of the graphite powder is preferably 0.1% by mass or more but 10% by mass or less, more preferably 1% by mass or more but 5% by mass or less, relative to the total amount of the filler. When the amount is less than 0.1% by mass, the graphite powder cannot exhibit its properties, not leading to improvement in thermal conductivity and an electrically conductive property. Meanwhile, when the amount is more than 10% by mass, dispersibility of the filler in the conductive paste will be deteriorated. As a result, a conductive paste having a significant difficulty in forming the conductive film will be obtained, which is not suitable for the present use.

The properties of the graphite powder are not particularly limited and may be appropriately selected depending on the intended purpose. For example, the BET specific surface area and the cumulative 50% point of particle diameter preferably satisfy the following ranges.

### ——BET Specific Surface Area of Graphite Powder——

A BET specific surface area of the graphite powder is preferably 0.1 m²/g or more but 5.0 m²/g or less, more preferably 0.3 m²/g or more but 2.0 m²/g or less.

The BET specific surface area of the graphite powder can be measured with Macsorb HM-model 1210 (manufactured by MOUNTECH Co.) by the single point BET method using nitrogen adsorption. Note that, in the measurement of the BET specific surface area, degassing before the measurement is performed at 60° C. for 10 minutes.

### ——Cumulative 50% Point of Particle Diameter (D₅₀) of Graphite Powder——

The cumulative 50% point of particle diameter (D₅₀) in the particle size distribution based on the volume of the graphite powder is preferably 0.1 μm or more but 30 μm or less, more preferably 1 μm or more but 25 μm or less.

The cumulative 50% point of particle diameter of the graphite powder can be measured through the particle size distribution measurement of the wet laser diffraction. That is, the particle size distribution measurement of the wet laser diffraction is performed as described below. Specifically, a graphite powder (0.1 g) is added to isopropyl alcohol (40 mL) and is dispersed for 2 minutes with an ultrasonic homogenizer having a tip diameter of 20 mm. Then, the laser diffraction scattering particle size distribution measuring apparatus (MICROTORAC MT3300EXII, manufactured by MicrotracBEL Corp.) is used for the measurement. Measurement results are graphed to determine frequency and accumulation of the particle size distribution of the silver powder. The cumulative 50% point of particle diameter is presented as “D₅₀”.

### —Silver Powder—

The silver powder is not particularly limited and may be appropriately selected depending on the intended purpose. Examples of the silver powder include a flaky silver powder, a dendritic silver powder, a spherical silver powder, and mixtures thereof. Among them, a mixture of a flaky silver powder and a spherical silver powder is preferable.

As the silver powder, an appropriately produced product may be used or a commercially available product may be used.

A method for producing the silver powder is, for example, a method for producing the silver powder by adding an aqueous solution containing a reducing agent to an aqueous reaction system containing silver ions to reduce and deposit the ion particles. As the silver powder, a silver powder formed of a material having a surface of silver and an inside of a material other than silver (e.g., silver-coated copper powder) may be used.

An amount of the silver powder is preferably 90% by mass or more but 99.9% by mass or less, more preferably 95% by mass or more but 99% by mass or less, relative to the total amount of the filler. When the amount is less than 90% by mass, an amount of carbon will become large, significantly deteriorating dispersibility of the filler in the conductive paste. As a result, a conductive paste having a significant difficulty in forming the conductive film will be obtained, which is not suitable for the present use. Meanwhile, when the amount is more than 99% by mass, the graphite powder cannot exhibit its properties, which may not lead to improvement in thermal conductivity and an electrically conductive property in some cases.

The properties of the silver powder are not particularly limited and may be appropriately selected depending on the intended purpose. For example, the BET specific surface area, the cumulative 50% point of particle diameter, and the ignition loss preferably satisfy the following ranges.

### ——BET Specific Surface Area of Silver Powder——

The BET specific surface area of the silver powder is preferably 0.1 m²/g or more but 5.0 m²/g or less, more preferably 0.3 m²/g or more but 2.0 m²/g or less.

The BET specific surface area of the silver powder can be measured in the same method as the method of the BET specific surface area of the graphite powder.

### ——Cumulative 50% Point of Particle Diameter of Silver Powder——

The cumulative 50% point of particle diameter (D₅₀) of the silver powder in the particle size distribution based on the volume through the laser diffraction particle size distribution measurement method is preferably 0.05 μm or more but 6.0 μm or less, more preferably 0.1 μm or more but 4.0 μm or less.

The cumulative 50% point of particle diameter of the silver powder can be measured in the same method as the method of the cumulative 50% point of particle diameter of the graphite powder.

### ——Ignition Loss of Silver Powder——

An ignition loss of the silver powder is not particularly limited and may be appropriately selected depending on the intended purpose, and is preferably 0.02% by mass to 1% by mass.

The ignition loss of the silver powder can be determined in the following manner. Specifically, a sample of the silver powder (2 g) is weighed (w1) and is charged into a porcelain crucible. Then, the porcelain crucible is ignited for 30 minutes at 800° C. until a constant weight is reached. Then, the porcelain crucible is cooled and is weighed (w2). The ignition loss of the silver powder can be determined by the following formula.

Ignition loss (% by mass)=−[(w1−w2)/w1]×100

### <Polymer>

The polymer is not particularly limited and may be appropriately selected depending on the intended purpose. Examples thereof include cellulose derivatives such as methyl cellulose and ethyl cellulose, acrylic resins, alkyd resins, polypropylene resins, polyurethane resins, rosin resins, terpene resins, phenol resins, aliphatic petroleum resins, acrylic ester resins, xylene resins, coumarone-indene resins, styrene resins, dicyclopentadiene resins, polybutene resins, polyether resins, urea resins, melamine resins, vinyl acetate resins, polyisobutyl resins, olefin-based thermoplastic elastomer (TPO), and epoxy resins. These may be used alone or in combination. Among them, an epoxy resin is preferable in terms of curing ability, close adhesiveness, and versatility.

As the epoxy resin, a monoepoxy compound, a multivalent epoxy compound, or a mixture thereof can be used. When the epoxy resin is used, a curing agent of the epoxy resin is preferably used in combination.

An amount of the polymer is not particularly limited and may be appropriately selected depending on the intended purpose.

### <Solvent>

The solvent is not particularly limited and may be appropriately selected depending on the intended purpose. Examples of the solvent include toluene, methyl ethyl ketone, methyl isobutyl ketone, tetradecane, tetralin, propyl alcohol, isopropyl alcohol, terpineol, dihydroterpineol, dihydroterpineol acetate, ethyl carbitol, butyl carbitol, ethyl carbitol acetate, butyl carbitol acetate, 2,2,4-trimethyl-1,3-pentanediol monoisobutyrate, and diethylene glycol mono-n-ethyl ether acetate. These may be used alone or in combination.

An amount of the solvent is not particularly limited and may be appropriately selected depending on the intended purpose.

### <Other Components>

The other components are not particularly limited and may be appropriately selected depending on the intended purpose. Examples thereof include a surfactant, a dispersing agent, a dispersion stabilizer, a viscosity modifier, a leveling agent, and an antifoaming agent.

A method for producing the conductive paste is not particularly limited and may be appropriately selected depending on the intended purpose. For example, the conductive paste can be prepared by mixing the filler, the polymer, the solvent, and if necessary the other components, using an ultrasonic disperser, a disper, a triple roll mill, a ball mill, a bead mill, a biaxial kneader, and a planetary centrifugal stirrer.

The conductive paste of the present invention can be printed on a substrate by, for example, screen printing, offset printing, or photolithography. In the case of the screen printing, a viscosity of the conductive paste is preferably 10 Pa·s or more but 800 Pa·s or less at 25° C. at a cone-spindle rotational speed of 1 rpm. When the viscosity of the conductive paste is less than 10 Pa·s, “bleeding” may occur upon printing. When the viscosity of the conductive paste is more than 800 Pa·s, printing unevenness such as “blurring” may occur.

The viscosity of the conductive paste can be adjusted by changing an amount of the filler, adding a viscosity modifier, or changing the kind of the solvent. The viscosity of the conductive paste can be measured at 25° C. (paste temperature) with a viscometer 5XHBDV-IIIUC (manufactured by BROOKFIELD) with a cone spindle CP-52.

The conductive paste of the present invention can be suitably used for forming the conductive film by directly coating or printing the conductive paste on a substrate such as a silicon wafer for solar cells, a film for touch panels, or a glass for EL elements, or by coating or printing the conductive paste on a transparent conductive film that is further formed on the substrate according to the necessity.

### (Conductive Film)

A conductive film of the present invention is formed of the conductive paste of the present invention.

A volume resistivity of the conductive film is preferably 100 μΩ·cm or less, more preferably 50 μΩ·cm or less. When the volume resistivity is 100 μΩ·cm or less, it is possible to realize the conductive film having a considerably low volume resistivity. When the volume resistivity is more than 100 μΩ·cm, the electrically conductive property of the conductive film may be insufficient.

The volume resistivity of the conductive film can be measured by calculating the following: Volume resistivity=Value of resistivity×Thichkess of conductive film×Width of conductive film+Length of conductive film, where the value of resistivity is a value of resistivity that is measured with a digital multimeter (R6551 manufactured by ADVANTEST) between two points in the longitudinal direction of the conductive film.

A thermal conductivity of the conductive film is preferably 10 W/m·K or more, more preferably 15 W/m·K or more. When the thermal conductivity is less than 10 W/m·K, the thermal conductivity of the conductive film may be insufficient.

The thermal conductivity can be measured through, for example, the laser flash method.

The conductive film of the present invention can be suitably used for collecting electrodes of solar cells, external electrodes of chip-type electronic components, and electrodes or electrical wirings of, for example, RFID, electromagnetic wave shields, adhesion of vibrator, membrane switches, and electroluminescence.

### EXAMPLES

The present invention will be described by way of the following Examples. However, the present invention should not be construed as being limited to these Examples.

Methods for measuring the BET specific surface area of the filler, the tap density, the particle size distribution (D₁₀, D₅₀, and D₉₀), the 1%-weight-reduction starting temperature, the ignition loss of the silver powder are as follows.

### <BET Specific Surface Area>

A silver powder (3 g) was charged into a cell of Macsorb HM-model 1210 (manufactured by MOUNTECH) and the cell was degassed at 60° C. for 10 minutes to measure the BET specific surface area through the single point BET method. The carrier gas used was He: 70% and N₂: 30%.

### <Tap Density>

A tap density was obtained with a tap density measuring device (bulk specific gravity measuring device SS-DA-2 manufactured by Shibayama Scientific Co., Ltd.). The silver powder (15 g) was weighed and was charged into a container (20 mL test tube). The tapping was performed for 1,000 times at a drop of 20 mm. The tap density was calculated by the following formula.

Tap density=Weight of the sample (15 g)/Volume of the sample after tapping

<Particle Size Distribution (D₁₀, D₅₀, and D₉₀)>

The particle size distribution was determined with a measurement device of laser diffraction scattering particle size distribution (MICROTORAC MT3300EXII manufactured by MicrotracBEL Corp.). Specifically, a silver powder (0.1 g) was added to isopropyl alcohol (40 mL) and was dispersed with an ultrasonic homogenizer having a chip diameter of 20 mm for 2 minutes to prepare a sample. Then, the particle diameter was measured under the total reflection mode. Then, values of a cumulative 10% point of particle diameter (D₁₀), a cumulative 50% point of particle diameter (D₅₀), and a cumulative 90% point of particle diameter (D₉₀) were determined by the cumulative distribution based on the volumes obtained through the measurement.

### <1%-Weight-Reduction Starting Temperature>

The 1%-weight-reduction starting temperature was determined by measuring a temperature at which the weight is reduced by 1% through the thermogravimetry·differential thermal analysis method (TG-DTA method) (thermal differential balance TG8120 manufactured by Rigaku Corporation) in a nitrogen atmosphere at a heating speed of 10° C./min.

### <Ignition Loss of Silver Powder>

The ignition loss of the silver powder was determined in the following manner.

Specifically, a sample of the silver powder (2 g) was weighed (w1) and was charged into a porcelain crucible. Then, the porcelain crucible was ignited for 30 minutes at 800° C. until a constant weight was reached. Then, the porcelain crucible was cooled and was weighed (w2). The ignition loss of the silver powder was determined by the following formula.

Ignition loss (% by mass)=[(w1−w2)/w1]×100

### Example 1

### —Preparation of Conductive Paste—

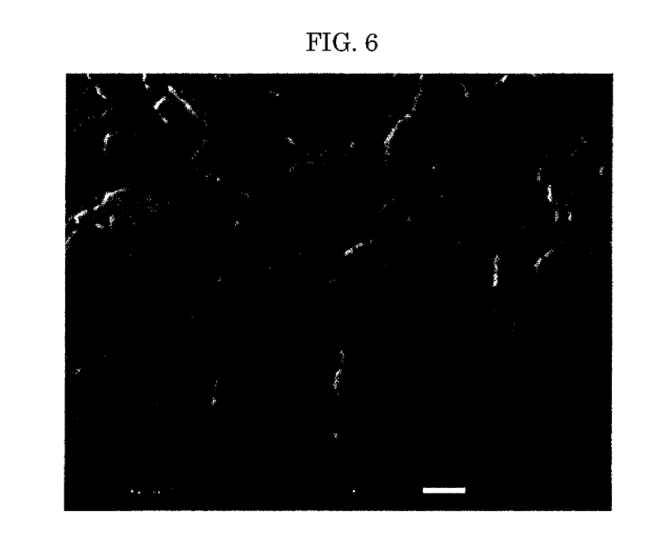

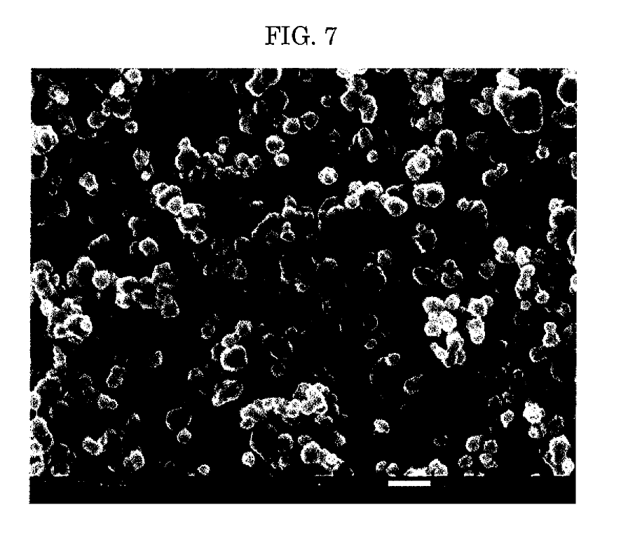

Graphene 1 (2.76 parts by mass) as a graphite powder, a flaky silver powder (manufactured by DOWA Electronics Materials Co., Ltd.) (53.544 parts by mass), a spherical silver powder (manufactured by DOWA Electronics Materials Co., Ltd.) (35.696 parts by mass), an epoxy resin (EP4901E, manufactured by ADEKA Corporation) (8 parts by mass), a curing agent (BF₃NH₂EtOH, manufactured by Wako Pure Chemical Industries, Ltd.) (0.4 parts by mass), oleic acid (manufactured by Wako Pure Chemical Industries, Ltd.) (0.1 parts by mass), and butyl carbitol acetate (manufactured by Wako Pure Chemical Industries, Ltd.) (2 parts by mass) as a solvent were added and were mixed with a propeller-free rotation and revolution stirring and defoaming apparatus (AR-250, manufactured by THINKY CORPORATION). Then, a triple roll mill (EXAKT80S, manufactured by EXAKT) was used to pass the mixture with the roll gaps being gradually narrowed. As a result, a conductive paste was obtained. Table 1 presents properties of the graphite powder used. Table 2 presents properties of the flaky silver powder used and the spherical silver powder used. Scanning electron microscopic images of the flaky silver powder used and the spherical silver powder used are presented in FIG. 6 and FIG. 7.

Next, the conductive paste obtained was measured for viscosity, volume resistivity 1, and thermal conductivity as described below. Results are presented in Table 3.

### <Viscosity of Conductive Paste>

The viscosity of the conductive paste obtained was measured at 25° C. (paste temperature) with a viscometer 5XHBDV-IIIUC (manufactured by BROOKFIELD) with a cone spindle CP-52. A value of the viscosity was measured at 1 rpm (shear rate 2 sec⁻¹) for 5 minutes.

### <Volume Resistivity 1>

The conductive paste was used to form a molded product having a diameter of 10 mm and a thickness of 1 mm and the molded product was cured at 200° C. for 20 minutes to prepare a sample.

The sample obtained was measured for the volume resistivity 1 through the four-point probe method (Loresta HP MCP-T410, manufactured by Mitsubishi Chemical Corporation).

### <Thermal Conductivity>

The conductive paste was used to form a molded product having a diameter of 10 mm and a thickness of 1 mm and the molded product was cured at 200° C. for 20 minutes to prepare a sample.

The sample obtained was measured for thermal diffusivity through the laser flash method (TC-7000, manufactured by ULVAC, Inc.) to determine the thermal conductivity based on specific heat and density.

### Example 2

A conductive paste was prepared in the same manner as in Example 1 except that the graphene 1 was changed to graphene 2 (GNH-X2, manufactured by Graphene Platform Corp.). Properties of the conductive paste were evaluated in the same manner as in Example 1. Results are presented in Table 3. Properties of the graphite powder used are presented in Table 1.

### Example 3

A conductive paste was prepared in the same manner as in Example 1 except that the graphene 1 was changed to a spheroidal graphite (WF-15C, manufactured by Chuetsu Graphite Works Co., Ltd.). Properties of the conductive paste were evaluated in the same manner as in Example 1. Results are presented in Table 3. Properties of the graphite powder used are presented in Table 1.

### Example 4

A conductive paste was prepared in the same manner as in Example 1 except that the graphene 1 was changed to a flake graphite (BF-15AK, manufactured by Chuetsu Graphite Works Co., Ltd.). Properties of the conductive paste were evaluated in the same manner as in Example 1. Results are presented in Table 3. Properties of the graphite powder used are presented in Table 1.

### Comparative Example 1

A conductive paste was prepared in the same manner as in Example 1 except that the graphene 1 was not added. Properties of the conductive paste were evaluated in the same manner as in Example 1. Results are presented in Table 3. Properties of the graphite powder used are presented in Table 1.

### Comparative Example 2

A conductive paste was prepared in the same manner as in Example 1 except that the graphene 1 was changed to graphite (manufactured by Sony Corporation). Properties of the conductive paste were evaluated in the same manner as in Example 1. Results are presented in Table 3. Properties of the graphite powder used are presented in Table 1.

TABLE 1

| | Graphite powder | | | | | | | |
|---|---|---|---|---|---|---|---|---|
| | | | BET | | 1.0%-weight- | Particle | | |
| | | | specific | | reduction | size | | |
| | | | surface | Tap | starting | distribution | | |
| | | Product | area | density | temperature | (μm) | | |
| No. | Kind | name | (m²/g) | (g/mL) | (° C.) | D₁₀ | D₅₀ | D₉₀ |
| 1 | Graphene | — | 29.32 | 0.051 | 536 | 0.9 | 4.1 | 9.3 |
| | 1 | | | | | | | |
| 2 | Graphene | GNH-X2 | 10.55 | 0.39 | 539 | 2.4 | 21.5 | 77.8 |
| | 2 | | | | | | | |
| 3 | Spheroidal | WF-15C | 6.27 | 0.96 | 593 | 12.0 | 17.3 | 25.8 |
| | graphite | | | | | | | |
| 4 | Flake | BF-15AK | 5.44 | 0.32 | 632 | 5.8 | 15.7 | 31.6 |
| | graphite | | | | | | | |
| 5 | Graphite | — | 13.3 | 0.31 | 648 | 3.2 | 8.3 | 17.5 |

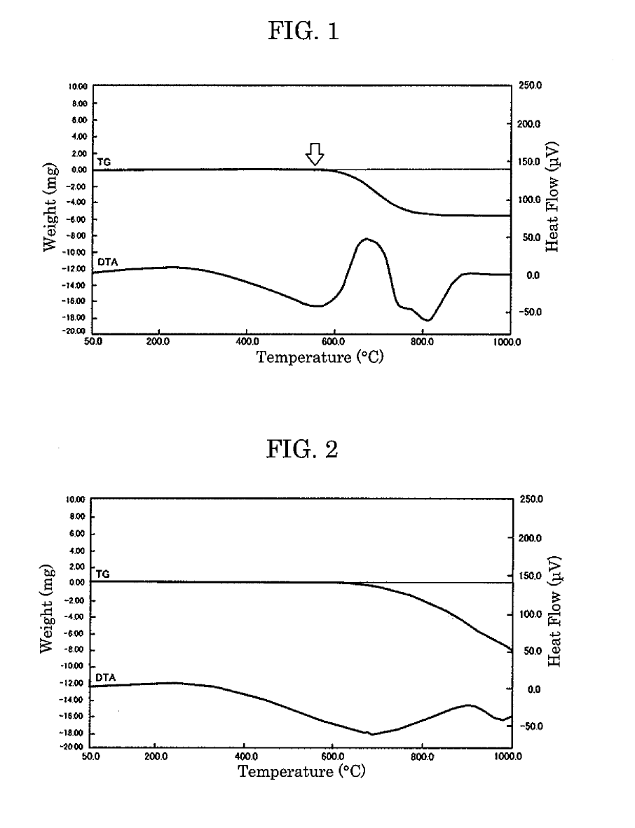

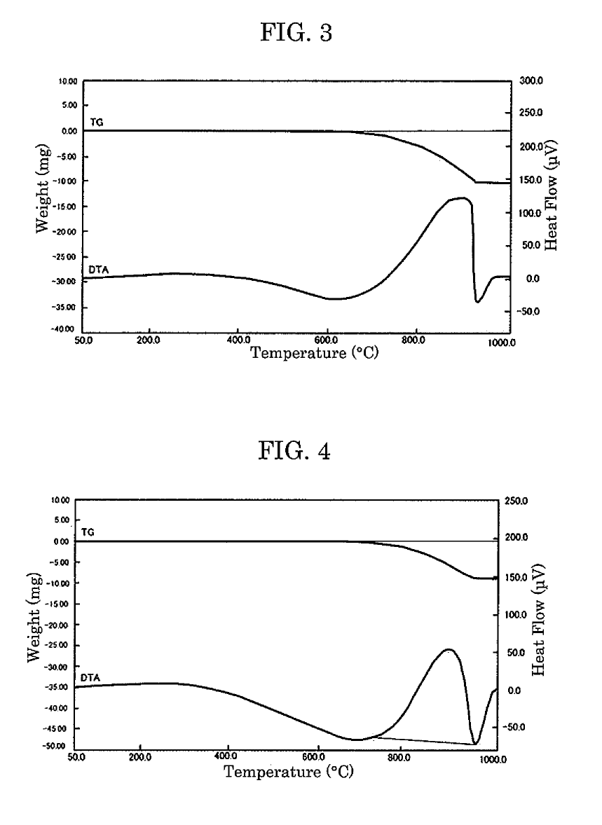

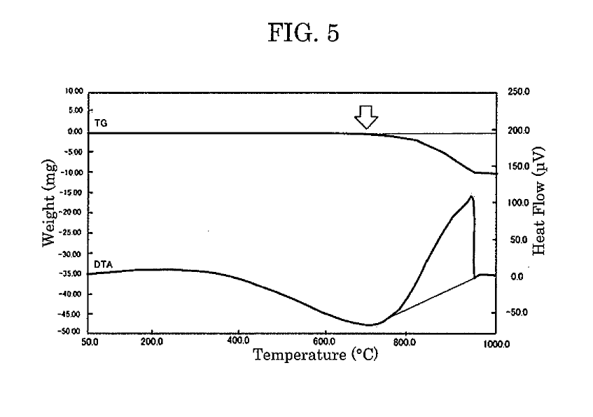

* Evaluation results of TG and DTA of the graphite powder No. 1 (graphene 1), which are measured through the thermogravimetry · differential thermal analysis method, are presented in FIG. 1.
* Evaluation results of TG and DTA of the graphite powder No. 2 (graphene 2), which are measured through the thermogravimetry · differential thermal analysis method, are presented in FIG. 2.
* Evaluation results of TG and DTA of the graphite powder No. 3 (spheroidal graphite), which are measured through the thermogravimetry · differential thermal analysis method, are presented in FIG. 3.
* Evaluation results of TG and DTA of the graphite powder No. 4 (flake graphite), which are measured through the thermogravimetry · differential thermal analysis method, are presented in FIG. 4.
* Evaluation results of TG and DTA of the graphite powder No. 5 (graphite), which are measured through the thermogravimetry · differential thermal analysis method, are presented in FIG. 5.

TABLE 2

| | Silver powder | | | | | | |
|---|---|---|---|---|---|---|---|
| | | BET | | | | | |
| | | specific | | | Particle size | | |
| | | surface | Tap | Ignition | distribution | | |
| | | area | density | loss | (μm) | | |
| No. | Kind | (m²/g) | (g/mL) | (%) | D₁₀ | D₅₀ | D₉₀ |
| 1 | Flaky | 0.95 | 5.1 | 0.91 | 1 | 2.2 | 4 |
| | silver | | | | | | |
| | powder | | | | | | |
| 2 | Spherical | 0.98 | 4.3 | 0.41 | 0.5 | 1.1 | 2.2 |
| | silver | | | | | | |
| | powder | | | | | | |

*An SEM image (×10,000) of the silver powder No. 1 (flaky silver powder) under the scanning electron microscope (SEM, JSM-6100, manufactured by JEOL Ltd.) is presented in FIG. 6.
*An SEM image (×10,000) of the silver powder No. 2 (spherical silver powder) under the scanning electron microscope (SEM, JSM-6100, manufactured by JEOL Ltd.) is presented in FIG. 7.

TABLE 3

| | | Example | Example | Example | Example | Comparative | Comparative |
|---|---|---|---|---|---|---|---|
| | | 1 | 2 | 3 | 4 | Example 1 | Example 2 |
| Graphite | Graphite | 2.76 | — | — | — | — | — |
| powder | powder No. 1 | | | | | | |
| | Graphite | — | 2.76 | — | — | — | — |
| | powder No. 2 | | | | | | |
| | Graphite | — | — | 2.76 | — | — | — |
| | powder No. 3 | | | | | | |
| | Graphite | — | — | — | 2.76 | — | — |
| | powder No. 4 | | | | | | |
| | Graphite | — | — | — | — | — | 2.76 |
| | powder No. 5 | | | | | | |
| Silver | Silver | 53.544 | 53.544 | 53.544 | 53.544 | 55.2 | 53.544 |
| powder | powder No. 1 | | | | | | |
| | Silver | 35.696 | 35.696 | 35.696 | 35.696 | 36.8 | 35.696 |
| | powder No. 2 | | | | | | |
| Epoxy resin | EP4901E | 8 | 8 | 8 | 8 | 8 | 8 |
| Curing | BF₃NH₂EtOH | 0.4 | 0.4 | 0.4 | 0.4 | 0.4 | 0.4 |
| agent | | | | | | | |
| Dispersing | Oleic acid | 0.1 | 0.1 | 0.1 | 0.1 | 0.1 | 0.1 |
| agent | | | | | | | |
| Solvent | Butyl | 2 | 2 | 2 | 2 | 2 | 2 |
| | carbitol | | | | | | |
| | acetate | | | | | | |
| Inorganic ratio (% by mass) | | 89.7 | 89.7 | 89.7 | 89.7 | 89.7 | 89.7 |
| Evaluation | Viscosity | 1850 | 1310 | 754 | 933 | 558 | 905 |
| Results | (Pa · s) | | | | | | |
| | Volume | 21 | 13 | 9 | 21 | 30 | 38 |
| | resistivity 1 | | | | | | |
| | (μΩ · cm) | | | | | | |
| | Thermal | 19.4 | 18.9 | 19.9 | 17.3 | 9.5 | 14.3 |
| | conductivity | | | | | | |
| | (W/m · K) | | | | | | |
| | Density | 4.3 | 4.4 | 3.7 | 4.3 | 3.6 | 4.2 |
| | (g/cm³) | | | | | | |

*A unit of an amount of each component in Table 3 is part(s) by mass.

### Example 5

### —Preparation of Conductive Paste—

The graphene 1 (3 parts by mass) as a graphite powder, a flaky silver powder (manufactured by DOWA Electronics Materials Co., Ltd.), (53.544 parts by mass), a spherical silver powder (manufactured by DOWA Electronics Materials Co., Ltd.) (35.696 parts by mass), an epoxy resin (EP4901E, manufactured by ADEKA Corporation) (8 parts by mass), a curing agent (BF₃NH₂EtOH, manufactured by Wako Pure Chemical Industries, Ltd.) (0.4 parts by mass); oleic acid (manufactured by Wako Pure Chemical Industries, Ltd.) (0.1 parts by mass), and butyl carbitol acetate (manufactured by Wako Pure Chemical Industries, Ltd.) (5.24 parts by mass) as a solvent were added and were mixed with a propeller-free rotation and revolution stirring and defoaming apparatus (AR-250, manufactured by THINKY CORPORATION). The resultant was passed through a triple roll mill (EXAKT80S, manufactured by EXAKT). Then, butyl carbitol acetate (manufactured by Wako Pure Chemical Industries, Ltd.) as a solvent was added thereto while the viscosity being confirmed, to thereby adjust the viscosity to from 500 Pa·s to 600 Pa·s. The resultant was passed with the roll gaps being gradually narrowed to obtain a conductive paste.

The conductive paste obtained was measured for viscosity and thermal conductivity in the same manner as in Example 1.

Then, the conductive paste was used to prepare a conductive film in the following manner. The conductive film was measured for an average thickness and volume resistivity 2. Results are presented in Table 4.

### <Preparation of Conductive Film>

Next, a film of the prepared conductive paste was formed on an alumina substrate through screen printing. The conditions of the screen printing were as follows.
Printing device: MT-320 T manufactured by Micro-tec Co., Ltd.
Plate: line width 500 μm, routing 37.5 mm, 250 mesh, line diameter 23 μm
Printing conditions: squeegee pressure 180 Pa, printing rate 80 mm/s, clearance 1.3 mm

Next, the film obtained was subjected to a heat treatment at 200° C. for 20 minutes with an atmospheric circulation drying apparatus. As described above, a conductive film was prepared.

### <Average Thickness of Conductive Film>

A surface roughness meter (SE-30D manufactured by Kosaka Laboratory Ltd.) was used to measure an average thickness of the conductive film, which was obtained by measuring a difference in level between a part at which no film was printed on an alumina substrate and a part at which the conductive film was formed on the alumina substrate.

### <Volume Resistivity 2>

A value of resistivity was measured with a digital multimeter (R6551 manufactured by ADVANTEST) at each position provided by dividing each conductive film in length (interval). The volume of the conductive film was determined based on the sizes (film thickness, width, and length) of each conductive film. From this volume and the value of resistivity, the volume resistivity 2 was obtained.

### Example 6

A conductive paste and a conductive film were prepared in the same manner as in Example 5 except that the graphene 1 was changed to a flake graphite (BF-15AK, manufactured by Chuetsu Graphite Works Co., Ltd.). Properties thereof were evaluated in the same manner as in the above. Results are presented in Table 4.

### Comparative Example 3

A conductive paste and a conductive film were prepared in the same manner as in Example 5 except that the graphene 1 was changed to graphite (manufactured by Sony Corporation). Properties thereof were evaluated in the same manner as in the above. Results are presented in Table 4.

TABLE 4

| | | | | Com- | Com- |
|---|---|---|---|---|---|
| | | | | parative | parative |
| | | Exam- | Exam- | Exam- | Exam- |
| | | ple 5 | ple 6 | ple 1 | ple 3 |
| Graphite | Graphite powder | 3 | — | — | — |
| powder | No. 1 | | | | |
| | Graphite powder | — | — | — | — |
| | No. 2 | | | | |
| | Graphite powder | — | — | — | — |
| | No. 3 | | | | |
| | Graphite powder | — | 3 | — | — |
| | No. 4 | | | | |
| | Graphite powder | — | — | — | 3 |
| | No. 5 | | | | |
| Silver | Silver powder | 53.544 | 53.544 | 55.2 | 53.544 |
| powder | No. 1 | | | | |
| | Silver powder | 35.696 | 35.696 | 36.8 | 35.696 |
| | No. 2 | | | | |
| Epoxy resin | EP4901E | 8 | 8 | 8 | 8 |
| Curing agent | BF₃NH₂EtOH | 0.4 | 0.4 | 0.4 | 0.4 |
| Dispersing | Oleic acid | 0.1 | 0.1 | 0.1 | 0.1 |
| agent | | | | | |
| Solvent | Butyl carbitol | 5.24 | 3.8 | 2 | 4.11 |
| | acetate | | | | |
| Inorganic ratio (% by mass) | | 87.0 | 88.2 | 89.7 | 87.9 |
| Evaluation | Viscosity (Pa · s) | 583 | 314 | 558 | 302 |
| results | Volume | 48.9 | 42.1 | 85.0 | 107.0 |
| | resistivity 2 | | | | |
| | (μΩ · cm) | | | | |
| | Thermal | 14.8 | 17.5 | 9.5 | 12.2 |
| | conductivity | | | | |
| | (W/m · K) | | | | |
| | Density (g/cm³) | 3.8 | 3.8 | 3.6 | 3.8 |

*A unit of an amount of each component in Table 4 is part(s) by mass.

### INDUSTRIAL APPLICABILITY

The conductive paste and the conductive film of the present invention can be suitably used for collecting electrodes of solar cells, external electrodes of chip-type electronic components, and electrodes or electrical wirings of, for example, RFID, electromagnetic wave shields, adhesion of vibrator, membrane switches, and electroluminescence.

1. A conductive paste comprising:
a filler containing a silver powder and a graphite powder;
a polymer; and
a solvent,
wherein a 1%-weight-reduction starting temperature of the graphite powder, which is determined through a thermogravimetry·differential thermal analysis method, is 300° C. or more but 640° C. or less.

2. The conductive paste according to claim 1,
wherein the 1%-weight-reduction starting temperature of the graphite powder, which is determined through the thermogravimetry·differential thermal analysis method, is 500° C. or more but 600° C. or less.

3. The conductive paste according to claim 1,
wherein the graphite powder is at least one selected from a graphene, a spheroidal graphite, and a flake graphite.

4. The conductive paste according to claim 1,
wherein an amount of the graphite powder is 0.1% by mass or more but 10% by mass or less relative to a total amount of the filler.

5. The conductive paste according to claim 1,
wherein the silver powder is a mixture of a flaky silver powder and a spherical silver powder.

6. The conductive paste according to claim 1,
wherein the polymer is an epoxy resin.

7. A conductive film, which is formed of the conductive paste according to claim 1.

8. The conductive film according to claim 7,
wherein the conductive film has a volume resistivity of 100 μΩ·cm or less and a thermal conductivity of 10 W/m·K or more.
